(19) United States
(12) Patent Application Publication
(10) Pub. No.: US 2023/0394755 A1
(43) Pub. Date: Dec. 7, 2023

(54) Displaying a Visual Representation of Audible Data Based on a Region of Interest

(71) Applicant: Apple Inc., Cupertino, CA (US)

(72) Inventors: Ioana Negoita, San Jose, CA (US); Alesha Unpingco, Milpitas, CA (US); Bryce L. Schmidtchen, San Francisco, CA (US); Devin W. Chalmers, Oakland, CA (US); Lee Sparks, Lake Forest, CA (US); Thomas J. Moore, Northglenn, CO (US)

(21) Appl. No.: 18/204,088

(22) Filed: May 31, 2023

Related U.S. Application Data
(60) Provisional application No. 63/348,267, filed on Jun. 2, 2022.

(51) Int. Cl. G06T 17/00; G06T 7/20; G06V 10/25; G06V 10/74; G06F 3/01; G06F 3/14; G10L 15/26

(52) U.S. Cl. CPC G06T 17/00; G06T 7/20; G06V 10/25; G06V 10/761; G06F 3/013; G06F 3/14; G10L 15/26; G06T 2207/20104

(57) ABSTRACT

A method includes presenting a representation of a three-dimensional (3D) environment from a current point-of-view. The method includes identifying a region of interest within the 3D environment. The region of interest is located at a first distance from the current point-of-view. The method includes receiving, via the audio sensor, an audible signal and converting the audible signal to audible signal data. The method includes displaying, on the display, a visual representation of the audible signal data at a second distance from the current point-of-view that is a function of the first distance between the region of interest and the current point-of-view.

### CROSS-REFERENCE TO RELATED APPLICATIONS

This application claims the benefit of U.S. Provisional Patent App. No. 63/348,267, filed on Jun. 2, 2022, which is incorporated by reference in its entirety.

### TECHNICAL FIELD

The present disclosure generally relates to displaying a visual representation of audible data based on a region of interest.

### BACKGROUND

Some devices present visual representations of audible information. Visual representations can include a transcript of audible spoken words or an audio portion of a media content item in verbatim or in edited form. Some visual representations may include descriptions of non-speech elements. The visual representations need not be hard-coded into the media content item thereby providing the user an option to view the visual representations or not view the visual representations. Most devices display the visual representations at a fixed display location.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1F are diagrams of an example operating environment in accordance with some implementations.

FIG. 2 is a block diagram of a system that displays a visual representation of audible data in accordance with some implementations.

FIG. 3 is a flowchart representation of a method of displaying a visual representation of audible data in accordance with some implementations.

FIG. 4 is a block diagram of a device that displays a visual representation of audible data in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a visual representation of audible signal data at a distance that is based on a region of interest. In some implementations, a device includes a display, an audio sensor, a non-transitory memory, and one or more processors coupled with the display, the audio sensor and the non-transitory memory. In various implementations, a method includes presenting a representation of a three-dimensional (3D) environment from a current point-of-view. In some implementations, the method includes identifying a region of interest within the 3D environment. In some implementations, the region of interest is located at a first distance from the current point-of-view. In some implementations, the method includes receiving, via the audio sensor, an audible signal and converting the audible signal to audible signal data. In some implementations, the method includes displaying, on the display, a visual representation of the audible signal data at a second distance from the current point-of-view that is a function of the first distance between the region of interest and the current point-of-view.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

While a device is presenting an XR environment, a user of the device can enable visual representations of data. The visual representations can include a speech transcript of a person in the XR environment. Additionally or alternatively, the visual representations can include a description of the XR environment. For example, the visual representations can include information regarding an object in the XR environment. In previously available devices, the visual representations are displayed at a particular location on a display. For example, the visual representations may be displayed towards a bottom of the display. If the user is focusing on a portion of the XR environment that does not overlap with the location of the visual representations, the user has to shift his/her focus to the location of the visual representations. Repeatedly shifting his/her focus between the location of the visual representations and other portions of the environment may impose a strain on the user's eyes. Moreover, requiring the user to shift his/her focus to the location of the visual representations may detract from a user experience of the device by requiring the user to look away from objects that may interest the user.

Moreover, previously available devices generally display visual representations at a fixed depth. For example, the visual representations may be displayed at a depth that coincides with a point-of-view of the device (e.g., at zero depth from the point-of-view of the device). If the visual representations are displayed at a fixed depth from the point-of-view of the device (e.g., at zero depth from the point-of-view of the device) and the user is gazing at an object that is at a different depth, the user has to repeatedly adjust a depth at which the user is focusing thereby imposing a strain on the user's eyes. Displaying visual representations at a close depth while the user is focusing on an object at a greater depth may impose an even greater strain on a user that is farsighted because the user may not be able to clearly view the visual representations.

The present disclosure provides methods, systems, and/or devices for displaying a visual representation of audio data in an XR environment at a location that is based on a region of interest. While the device is presenting an XR environment from a current point-of-view, the device identifies a region of interest within the XR environment. The region of interest is sometimes located at a particular distance from the current point-of-view. The device can identify the region of interest by determining that a user of the device is gazing at an object that is positioned at a first distance from the current point-of-view of the device. In order to reduce strain on the user's eyes, the device can display visual representations in such a manner that the visual representations appear to be positioned at the same distance as the region of interest. For example, the device can display the visual representations such that the visual representations appear to be positioned at the same distance as the object that the user is gazing at. Since the visual representations are displayed at the same distance as the region of interest, the user does not have to shift his/her focus between different distances thereby reducing strain on the user's eyes.

The distance between the region of interest and the current point-of-view may be referred to as a depth-of-focus since the user is currently focusing at that depth. The device displays the visual representations at a depth that matches the depth-of-focus. Rendering the visual representations at or near the same depth as the depth-of-focus tends to reduce strain on the user's eyes because the user does not have to adjust his/her eyes to focus at different depths. If the current point-of-view is assigned a depth of zero, the depth-of-focus is a number that is greater than zero. In order to ensure that the user can effectively read the visual representations, the device adjusts a font size of the visual representations based on the depth-of-focus. The font size may be directly related (e.g., proportional) to the depth-of-focus so that the user can effectively read the visual representations. As such, as the depth-of-focus increases, the device increases the font size of the visual representations.

After identifying the region of interest, the device can display visual representations at a location that overlaps with the region of interest. Displaying the visual representations in the same plane as the depth-of-focus reduces eye strain, for example, because the user does not have to adjust his/her focus between different depths. The device can further reduce eye strain by displaying the visual representations adjacent to the region of interest within the plane. For example, if the region of interest is towards a top-right corner of the plane, the device can display the visual representations near the top-right corner instead of displaying the visual representations at the bottom-center of the plane. Displaying the visual representations adjacent to the region of interest reduces the need for the user to shift his/her gaze between different portions of the plane.

The device can identify the region of interest by localizing a sound that the visual representations correspond to. For example, if the visual representations include a transcript of a person's speech, the device can identify the person in the XR environment and render the visual representations adjacent to the person's face and at the same depth as the person. As another example, if the visual representations include lyrics of a song being played by a media device, the device can identify the media device and render the visual representations adjacent to the media device and at the same depth as the media device.

The device can display visual representations in a head-locked manner so that the user can view the visual representations as the user rotates his/her head. The depth-of-focus may change over time as the user shifts his/her gaze within the environment to objects that are located at different depths. As the depth-of-focus changes, the device displays the visual representations at matching depths. As the device displays the visual representations at different depths, the device changes a font size of the visual representations so that the visual representations appear to be displayed at a constant font size. The device can render the visual representations based on a tiered approach. The device can categorize the depth-of-focus into one of several tiers, and display the visual representations at a depth that corresponds to the tier associated with the depth-of-focus.

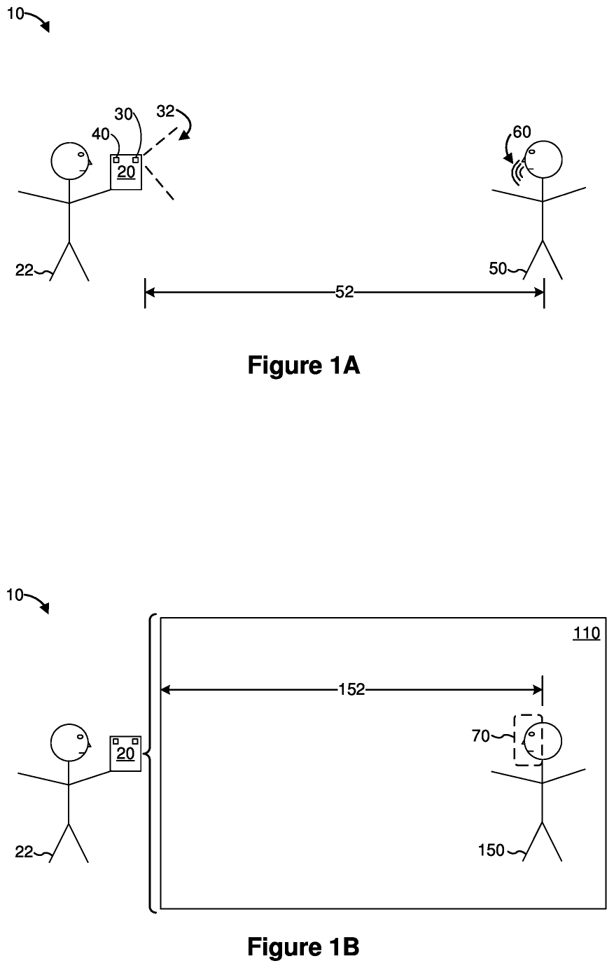

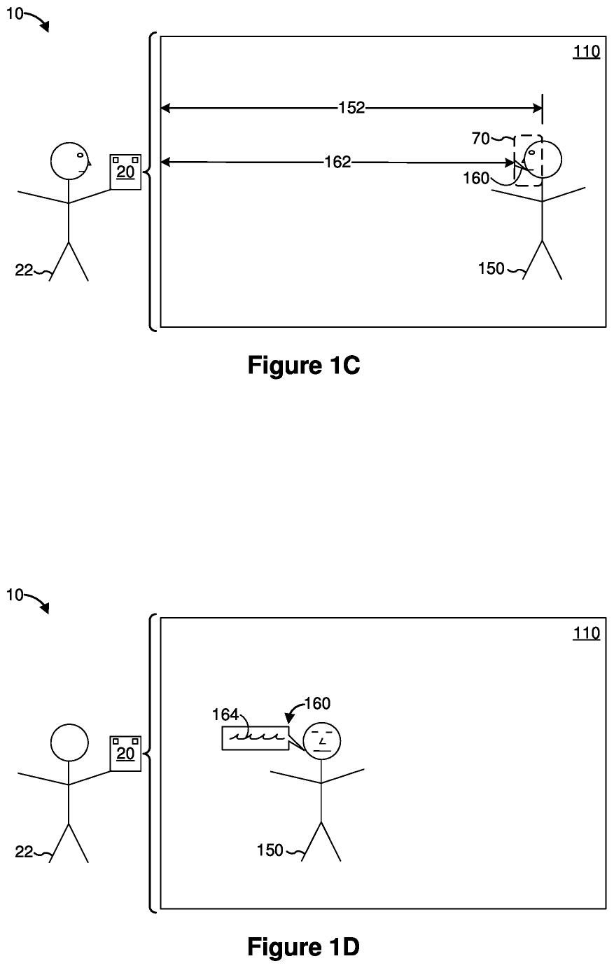

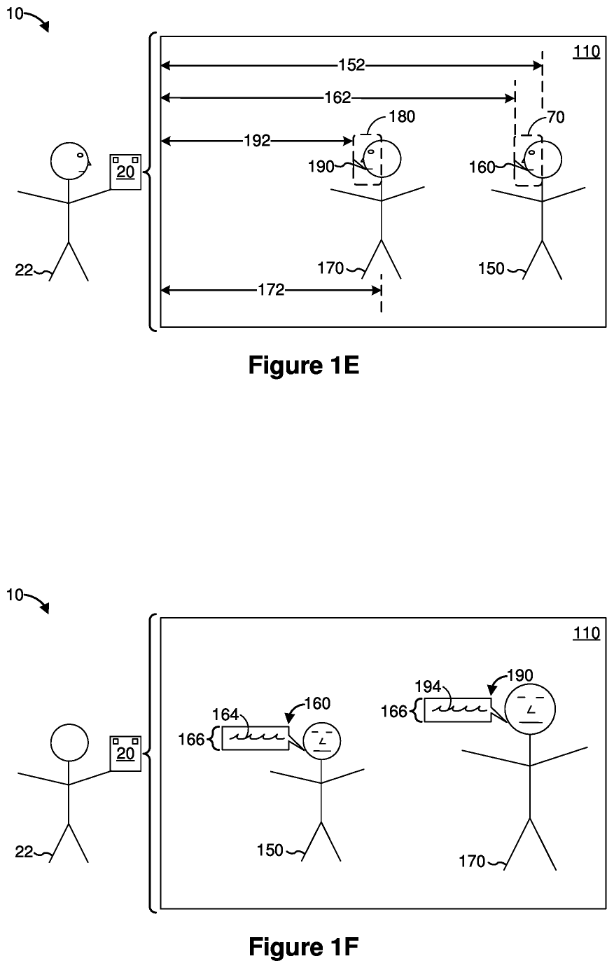

FIG. 1A is a diagram that illustrates an example physical environment 10 in accordance with some implementations. While pertinent features are shown, those of ordinary skill in the art will appreciate from the present disclosure that various other features have not been illustrated for the sake of brevity so as not to obscure more pertinent aspects of the example implementations disclosed herein. To that end, as a non-limiting example, the physical environment 10 includes an electronic device 20, a user 22 of the electronic device 20, and a person that is positioned at a distance 52 from the electronic device 20. The electronic device 20 includes an image sensor 30 that has a field-of-view 32. As can be seen in FIG. 1A, the person is in the field-of-view 32 of the image sensor 30. The electronic device 20 includes an audio sensor 40 for receiving an audible signal and converting the audible signal into audible signal data. In the example of FIG. 1A, the person 50 is uttering speech 60. The audio sensor 40 receives an audible signal that corresponds to the speech 60 and converts the audible signal to audible signal data.

In some implementations, the electronic device 20 includes a handheld computing device that can be held by the user 22. For example, in some implementations, the electronic device includes a smartphone, a tablet, a media player, a laptop, or the like. In some implementations, the electronic device 20 includes a wearable computing device that can be worn by the user 22. For example, in some implementations, the electronic device 20 includes a head-mountable device (HMD) or an electronic watch. In some implementations, the electronic device 20 includes a smartphone or a tablet, and the image sensor 30 includes a rear-facing camera that captures an image of the person 50 when the user 22 points the rear-facing camera towards the person 50. In some implementations, the electronic device 20 includes an HMD, and the image sensor 30 includes a scene-facing camera that captures an image of the person 50 when the user 22 looks at the person 50.

In some implementations, the electronic device 20 determines to generate and display a transcript of the speech 60 in response to a voice characteristic (e.g., an amplitude, a speed and/or a language) of the speech 60 being outside an audible speech range. In some implementations, the electronic device 20 generates and displays visual representations for the speech 60 when an amplitude of the speech 60 is below a threshold amplitude. For example, the electronic device 20 displays a transcript of the speech 60 when the person 50 is speaking too softly for the user 22 to properly hear the speech 60 but loud enough for the audio sensor 40 to detect the speech 60. In some implementations, the electronic device 20 determines to generate and display a transcript of the speech 60 when a speed at which the person 50 is speaking is greater than a threshold speed. In some implementations, the electronic device 20 determines to generate and display a transcript of the speech 60 when a language in which the person 50 is speaking is different from a preferred language of the user 22. In some implementations, the electronic device determines to generate and display visual representations for the physical environment 10 when an ambient sound level of the physical environment 10 is greater than a threshold sound level (e.g., when the physical environment 10 is too loud for the user 22 to hear the speech 60). In some implementations, the electronic device 20 determines to generate and display visual representations for the physical environment 10 in response to determining that the user 22 is audially impaired. In some implementations, the user 22 generally uses a wearable hearing aid device, and the electronic device 20 determines to generate and display a transcript of the speech in response to detecting that the user 22 is currently not wearing the wearable hearing aid device.

Referring to FIG. 1B, the electronic device 20 presents an XR environment 110 that corresponds to the physical environment 10 shown in FIG. 1A. In some implementations, the XR environment 110 is a pass-through (e.g., a video pass-through or an optical see-through) of the physical environment 10. As such, the XR environment 110 includes corresponding XR representations of physical articles that are in the physical environment 10 shown in FIG. 1A. For example, the XR environment 110 includes an XR representation 150 of the person 50. The XR representation 150 of the person 50 is displayed at a first depth 152. The first depth 152 corresponds to the distance 52 between the electronic device 20 and the person 50 in the physical environment 10.

In various implementations, the electronic device 20 provides the user 22 an option to view a textual description of sounds in the XR environment 110. For example, the electronic device 20 may provide a visual representations option that, when activated, generates and displays visual representations for the XR environment 110. When the user 22 enables visual representations for the XR environment 110, the electronic device 20 generates a transcription of the speech 60 uttered by the person 50. If there are multiple people in the physical environment 10 that are uttering speech, the electronic device 20 can provide the user 22 an option to select which person's speech to transcribe and which person's speech to not transcribe. The electronic device may be associated with a default language. For example, the user 22 may have specified a preferred language during a setup operation. If the speech 60 is in a different language from the preferred language specified during the setup operation, the electronic device 20 can translate the speech 60 into the preferred language and display a transcript of the speech 60 in the preferred language.

In various implementations, the electronic device 20 identifies a region of interest within the XR environment 110. The region of interest 70 corresponds to a volumetric space that the user 22 appears to be interested in. In some implementations, the electronic device 20 identifies the region of interest 70 based on a gaze of the user 22. The electronic device 20 can determine where the user 22 is gazing based on image data captured by a user-facing camera. In some implementations, the electronic device 20 identifies the region of interest 70 based on a location of an audible signal in the XR environment 110. The electronic device 20 identifies the location of the audible signal as the region of interest 70, for example, because the user 22 may be expected to gaze at the source of the audible signal. In the example of FIG. 1B, the electronic device 20 identifies a face of the XR representation 150 of the person 50 as the region of interest because the person 50 is uttering the speech 60 and the user 22 is expected to look at a face of the XR representation 150 while the person 50 is uttering the speech 60. Since the XR representation 150 of the person 50 is at the first depth 152, the region of interest 70 is at the first depth 152.

Referring to FIG. 1C, the electronic device 20 generates and displays a visual representation 160 of the speech 60 at a second depth 162. The visual representation 160 includes a transcript of the speech 60. The transcript of the speech 60 may be in the same language as the speech 60. Alternatively, the electronic device 20 may generate the transcript in a different language (e.g., in a language that the user 22 frequently communicates in). Additionally or alternatively, the visual representation 160 may include non-verbal elements. For example, the visual representation 160 may indicate a mood of the person 50 (e.g., the visual representation 160 may state whether the person 50 said something happily or angrily). The visual representation 160 may indicate a pose of the person 50 (e.g., the visual representation 160 may state whether the person 50 slouched or stood up straight while uttering the speech 60). The visual representation 160 may indicate a change in a state of another object in the XR environment 110 (e.g., the visual representation 160 may specify that a door was shut, a light was turned on, etc.).

The electronic device 20 selects the second depth 162 for displaying the visual representation 160 based on the first depth 152 of the region of interest 70. In some implementations, the second depth 162 is the same as (e.g., equal to) the first depth 152. In some implementations, the second depth 162 is within a threshold of the first depth 152. In some implementations, the electronic device 20 categorizes the first depth 152 into one of several depth tiers. Each depth tier is associated with a depth for displaying visual representations, and the electronic device 20 selects the second depth 162 by selecting the depth associated with the depth tier of the first depth 152.

In some implementations, the electronic device 20 determines whether the user 22 is visually impaired, and the electronic device 20 selects the second depth 162 based on a visual impairment of the user 22. In some implementations, the electronic device 20 determines that the user 22 is farsighted, and the electronic device 20 selects the second depth 162 such that the second depth 162 matches the first depth 152 or is slightly greater than the first depth 152 in order to reduce eye strain on the user 22. In some implementations, the electronic device 20 determines that the user 22 is nearsighted, and the electronic device 20 selects the second depth 162 such that the second depth 162 is slightly less than the first depth 152 in order to reduce eye strain on the user 22. Adjusting the depth at which the visual representations are displayed may help reduce eye strain if the user 22 is visually impaired and/or if the user 22 has difficulty in adjusting his/her optical focus between different depths.

While FIG. 1C illustrates a side view of the XR environment 110, FIG. 1D illustrates a front view of the XR environment 110 as the user 22 would see the XR environment 110. As can be seen in FIG. 1D, the visual representation 160 includes text 164 that corresponds to a transcript of the speech 60 being spoken by the person 50 in the physical environment 10. To further reduce eye strain, the electronic device 20 displays the text 164 adjacent to a face of the XR representation 150 instead of displaying the text 164 at a bottom of the display. Displaying the text 164 adjacent to the face reduces the need for the user 22 to shift his/her gaze between different locations on the display thereby reducing eye strain on the user 22. While adjusting the depth of the visual representations may be referred to as a z-dimension adjustment, adjusting a location of the visual representations within a plane of focus may be referred to as an x-y dimensions adjustment.

Referring to FIGS. 1E and 1F, in some implementations, the electronic device 20 displays different visual representations at different depths. In the example of FIGS. 1E and 1F, the XR environment 110 includes an XR representation 170 of another person, for example, because the other person is present in the physical environment 10 shown in FIG. 1A. The XR representation 170 of the other person is displayed at a third depth 172 that is based on a distance between the electronic device 20 and the other person in the physical environment 10. The electronic device 20 identifies a face of the XR representation 170 as a second region of interest 180, for example, because the other person is uttering speech. The electronic device 20 generates and displays a second visual representation 190 of the speech being uttered by the other person at a fourth depth 192 that is based on the third depth 172. Similar to the relation between the second depth 162 and the first depth 152, the fourth depth 192 may be the same as the third depth 172 or within a threshold of the third depth 172. As can be seen in FIG. 1E, the fourth depth 192 at which the electronic device 20 displays the second visual representation 190 is less than the second depth 162 at which the electronic device 20 displays the visual representation 160 because the other person is physically closer to the electronic device 20 than the person 50 in the physical environment 10.

While FIG. 1E illustrates a side view of the XR environment 110 with XR representations of two persons, FIG. 1F illustrates a front view of the XR environment 110 with the XR representations of the two persons. The XR representation 170 of the other person appears larger than the XR representation 150 of the person 50 because the other person is physically closer to the electronic device 20 than the person 50 in the physical environment 10. As shown in FIG. 1F, the second visual representation 190 includes text 194 that corresponds to a transcript of speech spoken by the other person. In various implementations, the electronic device 20 selects respective font sizes for the texts 164 and 194 such that the texts 164 and 194 appear to have a common font size 166. For example, the electronic device 20 increases the font size for the text 164 to compensate for the greater depth at which the text 164 is displayed.

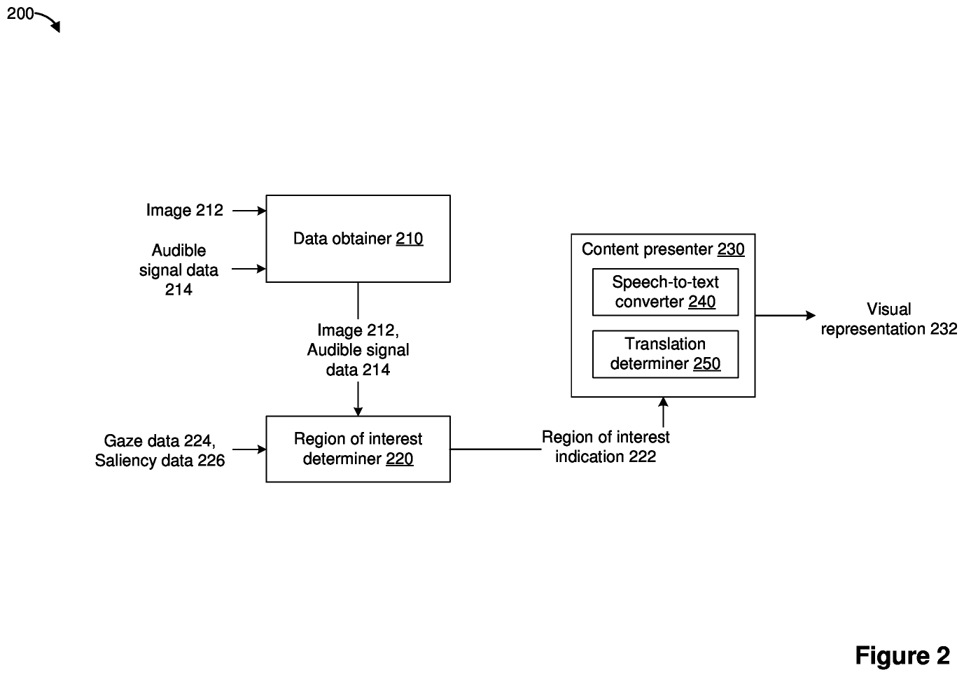

FIG. 2 is a block diagram of a system 200 that displays visual representations for an XR environment at a depth that is based on a region of interest. In some implementations, the system 200 includes a data obtainer 210, a region of interest determiner 220 and a content presenter 230. In various implementations, the system 200 resides at (e.g., is implemented by) the electronic device 20 shown in FIGS. 1A-1F.

In various implementations, the data obtainer 210 obtains an image 212 from an image sensor (e.g., the image sensor 30 shown in FIG. 1A). The image 212 depicts a portion of a physical environment surrounding the system 200 (e.g., a portion of the physical environment 10 that is in the field-of-view 32 shown in FIG. 1A). In various implementations, the data obtainer 210 obtains audible signal data 214 that corresponds to the physical environment surrounding the system 200 (e.g., audible signal data corresponding to the speech 60 shown in FIG. 1A). In various implementations, the image 212 includes a two-dimensional (2D) representation of a physical article in a physical environment and the audible signal data 214 corresponds to a sound that the physical article is generating. For example, the image includes a 2D representation of the person 50 shown in FIG. 1A and the audible signal data 214 encodes the speech 60 of the person 50.

In various implementations, the region of interest determiner 220 generates a region of interest indication 222 that indicates a region of interest within the XR environment (e.g., the region of interest 70 shown in FIG. 1B). In some implementations, the region of interest determiner 220 identifies the region of interest based on gaze data 224 that indicates a portion of the image 212 that a user is currently gazing at. For example, if the user gazes at a portion of the image 212 for more than a threshold amount of time, the region of interest determiner 220 identifies that portion of the image 212 as the region of interest. In some implementations, the gaze data 224 includes a gaze vector that indicates a gaze position, a gaze duration and/or a gaze intensity of the user. In some implementations, the gaze data 224 includes image data from an eye tracking camera and the region of interest determiner 220 identifies the gaze position, the gaze duration and/or the gaze intensity based on the image data from the eye tracking camera.

In some implementations, the region of interest determiner 220 generates the region of interest indication 222 based on saliency data 226. In some implementations, the saliency data 226 indicates which part of the image 212 is the most salient part. In such implementations, the region of interest determiner 220 selects the most salient part of the image 212 as the region of interest. In some implementations, the region of interest determiner 220 determines the saliency data 226 for the image 212 based on human-curated saliency data for similar images.

In some implementations, the region of interest determiner 220 includes a machine-learned model that identifies the region of interest. In some implementations, the machine-learned model is trained with a corpus of images for which an operator (e.g., a human operator) has identified the respective regions of interest. In such implementations, the region of interest determiner 220 determines the region of interest by providing the image 212 to the machine-learned model and the machine-learned model generates the region of interest indication 222.

In various implementations, the content presenter 230 generates a visual representation 232 of the audible signal data 214. In some implementations, the content presenter 230 includes a speech-to-text converter 240 that converts speech represented by the audible signal data 214 to text. In some implementations, the content presenter 230 includes a translation determiner 250 that translates speech represented by the audible signal data 214 from a source language to a target language (e.g., to a preferred language of the user).

In some implementations, the visual representation 232 includes non-verbal elements. In some implementations, the content presenter 230 includes a pose determiner that determines a pose of a person that uttered speech represented by the audible signal data 214. In such implementations, the visual representation 232 can specify the pose of the person. For example, if the pose determiner determines that a pose of the speaker has changed from a seated pose to a standing pose, the visual representation 232 may include text that states “He stands up”.

In various implementations, the content presenter 230 determines a depth for displaying the visual representation 232. The content presenter 230 determines a depth of the region of interest and selects the depth for the visual representation 232 based on the depth of the region of interest. In some implementations, the content presenter 230 displays the visual representation 232 at the same depth as the region of interest. In some implementations, the region of interest is a volumetric region that spans multiple depths. In such implementations, the depth of the visual representation 232 is a function of the multiple depths that the volumetric region spans. For example, the depth of the visual representation 232 may be an average of the depths that the volumetric region spans. As another example, the depth of the visual representation 232 may be set to the smallest or the greatest of the depths that the volumetric region spans.

In some implementations, the depth of the visual representation 232 is within a threshold of the depth of the region of interest. In some implementations, the content presenter 230 categorizes the depth of the region of interest into one of several depth tiers. Each depth tier may be associated with a different depth for the visual representation 232, and the content presenter 230 displays the visual representation 232 at the depth associated with the depth tier of the region of interest. In various implementations, displaying the visual representation 232 at or near the same depth as the region of interest reduces eye strain by reducing the need for the user to shift his/her gaze between significantly different depths.

In some implementations, the content presenter 230 determines a position for displaying the visual representation 232 in other dimensions in addition to or as an alternative to determining the depth at which the visual representation 232 is to be displayed. In some implementations, the content presenter 230 positions the visual representation 232 such that the visual representation 232 is near (e.g., adjacent to) the region of interest horizontally and/or vertically. In some implementations, displaying the visual representation 232 horizontally and/or vertically near the region of interest further reduces eye strain by reducing the need for the user to shift his/her gaze horizontally and/or vertically between the region of interest and the visual representation 232.

In some implementations, the content presenter 230 displays the visual representation 232 at a position that is different from a default position in response to obtaining an indication that displaying the visual representation 232 at the default position may result in undue eye strain. In some implementations, the content presenter 230 has access to health data that indicates an eye condition of the user. The content presenter 230 can display the visual representation 232 at a non-default position to reduce eye strain when the health data indicates that the eye condition of the user is outside an acceptable range. For example, the content presenter 230 can display the visual representation 232 at the same depth as the region of interest when the health data indicates that having to shift focus between different depths will likely result in undue eye strain. As another example, the content presenter 230 can display the visual representation 232 near a horizontal position and/or near a vertical position of the region of interest when the health data indicates that having to shift gaze between the region of interest and a default horizontal position or a default vertical position will likely result in undue eye strain.

In some implementations, the content presenter 230 estimates an eye condition of the user (e.g., a level of tiredness of the user's eye) based on screen time data that indicates an amount of time that the user has viewed a display during a particular time duration. For example, if the screen time data indicates that the user has exceeded his/her average daily screen time by a threshold, then the content presenter 230 displays the visual representation 232 at a position that is based on a position of the region of interest. As an example, if the user has exceeded his/her average daily screen time by a threshold percentage (e.g., 20 percent), the content presenter 230 displays the visual representation 232 at a depth that is based on a depth of the region of interest, at a horizontal position that is based on a horizontal position of the region of interest and/or at a vertical position that is based on a vertical position of the region of interest.

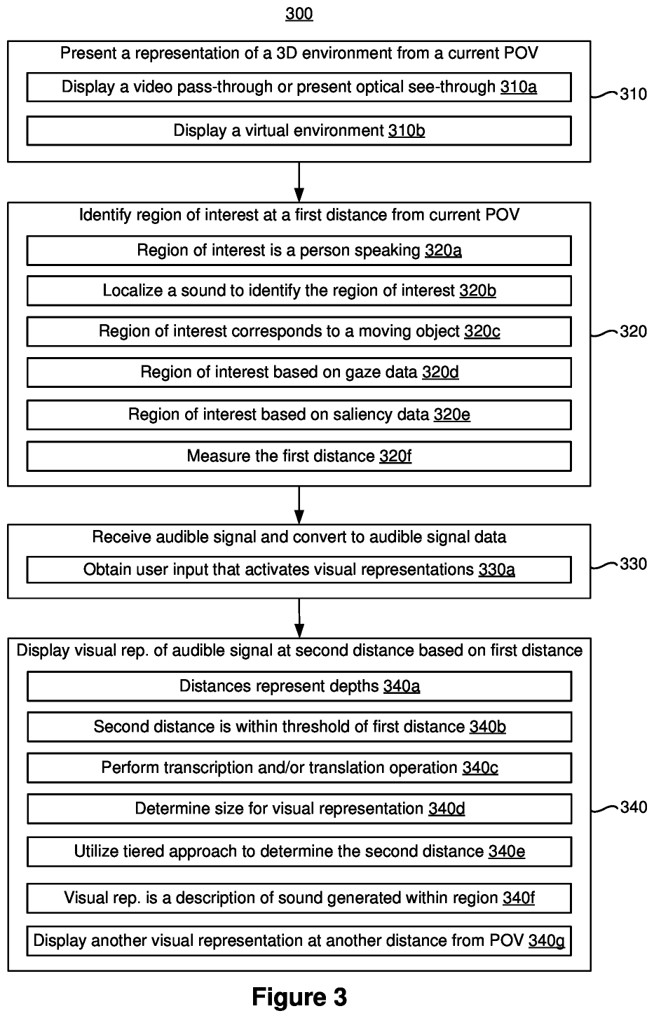

FIG. 3 is a flowchart representation of a method 300 for displaying a visual representation of audible data at a position within an XR environment that is based on a position of a region of interest. In various implementations, the method 300 is performed by a device including a display, an image sensor, an audio sensor, a non-transitory memory and one or more processors coupled with the display, the image sensor, the audio sensor and the non-transitory memory (e.g., the electronic device 20 shown in FIGS. 1A-1F and/or the system 200 shown in FIG. 2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes presenting a representation of a three-dimensional (3D) environment from a current point-of-view. For example, as shown in FIG. 1B, the electronic device 20 presents the XR environment 110 from a point-of-view that corresponds to a position of the electronic device 20 within the physical environment 10 shown in FIG. 1A.

As represented by block 310a, in some implementations, presenting the representation of the 3D environment includes displaying a video pass-through of a physical environment. For example, the electronic device 20 may present the XR environment 110 shown in FIG. 1B by capturing a series of images captured by the image sensor 30 and displaying the captured series of images on an opaque display (e.g., a video pass-through display) without persistently storing the series of images in a non-transitory memory of the electronic device 20. In some implementations, presenting the representation of the 3D environment includes presenting an optical see-through of a physical environment. For example, the electronic device 20 may include an optical see-through display, and the electronic device 20 presents the XR environment 110 shown in FIG. 1B by allowing light from the physical environment 10 to enter an eye of the user 22 through the optical see-through display.

As represented by block 310b, in some implementations, presenting the representation of the 3D environment includes displaying a virtual environment that is different from a physical environment of the device. In some implementations, the method 300 includes generating a synthetic environment (e.g., a fictional environment) and displaying the synthetic environment on a display of the device.

As represented by block 320, in various implementations, the method 300 includes identifying a region of interest within the 3D environment. In some implementations, the region of interest is located at a first distance (e.g., a first depth) from the current point-of-view. For example, as shown in FIG. 1B, the region of interest 70 is located at the first depth 152 relative to a current point-of-view from which the electronic device 20 is presenting the XR environment 110. In various implementations, the method 300 includes identifying the region of interest by identifying a portion of the 3D environment that a user of the device is currently focusing on or is expected to focus on. In some implementations, the region of interest includes a volumetric space. Alternatively, in some implementations, the region of interest includes a two-dimensional (2D) surface (e.g., a 2D plane).

As represented by block 320a, in some implementations, the region of interest includes a representation of a person that is generating the audible signal, and the visual representation includes a transcript that is displayed near the representation of the person. For example, as shown in FIGS. 1B and 1C, the region of interest 70 includes a face of the XR representation 150 of the person 50 because the person 50 is uttering the speech 60 shown in FIG. 1A, and, as shown in FIG. 1D, the visual representation 160 includes the text 164 that represents a transcript of the speech 60.

As represented by block 320b, in some implementations, identifying the region of interest includes localizing the audible signal to identify a source of the audible signal in the environment, and selecting a position of the source of the audible signal as the region of interest. For example, referring to FIGS. 1A and 1B, the audio sensor 40 receives an audible signal corresponding to the speech 60, the electronic device 20 localizes the audible signal in order to determine that the audible signal is originating from the person 50, and the electronic device 20 selects a position of a face of the person 50 as the region of interest 70.

As represented by block 320c, in some implementations, identifying the region of interest includes detecting movement of an object in the 3D environment, and selecting a position of the object as the region of interest. As an example, referring to FIG. 1A, the electronic device 20 may obtain image data captured by the image sensor 30 and utilize the image data to identify a physical article that is moving within the physical environment 10. In this example, the electronic device 20 can set a position of the moving object as the region of interest. Since the object is moving, the region of interest moves with the object. As another example, referring to FIG. 1A, the electronic device 20 may select a mouth of the person 50 as the region of interest 70 since the mouth is most likely moving while the person 50 is uttering the speech 60. In some implementations, detecting the movement of the object includes detecting the movement based on an image of the 3D environment (e.g., based on image data captured by the image sensor 30 shown in FIG. 1A). In some implementations, detecting the movement of the object includes detecting the movement based on depth data of the 3D environment (e.g., based on depth data captured by a depth sensor of the electronic device shown in FIGS. 1A-1F).

As represented by block 320d, in some implementations, identifying the region of interest includes identifying the region of interest based on gaze data that indicates a gaze position of a user of the device. For example, as shown in FIG. 2, in some implementations, the region of interest determiner 220 generates the region of interest indication 222 based on the gaze data 224. In some implementations, the device includes a user-facing image sensor that captures images of the user's eye(s) and the device uses images from the user-facing image sensor to determine a gaze position, a gaze duration and/or a gaze intensity.

As represented by block 320e, in some implementations, identifying the region of interest includes identifying the region of interest based on a saliency map of the 3D environment. For example, as shown in FIG. 2, in some implementations, the region of interest determiner 220 generates the region of interest indication 222 based on the saliency data 226. In some implementations, the device determines which portion of the XR environment is most salient by comparing the XR environment with other environments with available saliency data.

As represented by block 320f, in some implementations, the first distance represents a distance between the device and the region of interest within the 3D environment. For example, referring to FIGS. 1A and 1B, the first depth 152 at which the XR representation 150 of the person 50 is displayed represents the distance 52 between the electronic device 20 and the person 50 in the physical environment 10. In some implementations, the method 300 includes determining the first distance based on depth data from a depth camera. For example, the electronic device 20 determines the distance 52 based on depth data captured by a depth camera. In some implementations, the method 300 includes determining the first distance based on sensor data from a lidar. For example, the electronic device 20 may include a lidar and the electronic device 20 can determine the distance 52 based on sensor data captured by the lidar.

As represented by block 330, in some implementations, the method 300 includes receiving, via the audio sensor, an audible signal and converting the audible signal to audible signal data. For example, as shown in FIG. 1A, the audio sensor 30 receives an audible signal that corresponds to the speech 60, and the audio sensor 30 converts the audible signal to audible signal data. As represented by block 330a, in some implementations, the method 300 includes converting the audible signal to audible signal data in response to obtaining a user input that corresponds to a request to display visual representations corresponding to the 3D environment. For example, the device activates the audio sensor and transcribes speech detected via the audio sensor in response to the request to display the visual representations.

As represented by block 340, in various implementations, the method 300 includes displaying, on the display, a visual representation of the audible signal data at a second distance from the current point-of-view that is a function of the first distance between the region of interest and the current point-of-view. For example, as shown in FIG. 1C, the electronic device 20 displays the visual representation 160 of the speech 60 at the second depth 162 that is a function of the first depth 152. In some implementations, the second distance is the same as the first distance. For example, as described herein, in some implementations, the electronic device 20 displays the visual representations at the same depth as the depth-of-focus.

As represented by block 340a, in some implementations, the first distance represents a first depth at which the region of interest is located and the second distance represents a second depth at which the visual representation is displayed. For example, as shown in FIG. 1C, the region of interest 70 is located at the first depth 152 and the visual representation 160 is displayed at the second depth 162.

As represented by block 340b, in some implementations, the second distance is within a threshold distance of the first distance. For example, in some implementations, the device displays the visual representations at a depth that is near the depth of the region of interest. In some implementations, the device categorizes the first distance into one of several categories. Each category is associated with a depth for displaying visual representations and the device sets the second distance to a depth associated with a category of the first distance. In some implementations, the second distance is the same as the first distance. For example, in some implementations, the device displays visual representations at the same depth as the region of interest.

As represented by block 340c, in some implementations, the visual representation of the audible signal data includes a transcript of speech represented by the audible signal data. For example, as shown in FIG. 1D, the visual representation 160 includes text 164 that represents a transcript of the speech 60 shown in FIG. 1A. In some implementations, the method 300 includes generating the transcript by performing a speech-to-text operation on the audible signal data. For example, as shown in FIG. 2, the content presenter 230 includes a speech-to-text converter 240 that generates a transcript for speech encoded by the audible signal data 214. In some implementations, the method 300 includes translating the speech from a first language to a second language associated with the device. For example, as shown in FIG. 2, the content presenter 230 includes a translation determiner 250 that translates the speech from an original language to a target language (e.g., to a preferred language of the user or to a default language associated with the device).

As represented by block 340d, in some implementations, the visual representation includes text that is displayed at a threshold size. In some implementations, the device adjusts a font size of the visual representation so that the text size appears to stay constant regardless of the depth at which the text is displayed. For example, as shown in FIG. 1F, the texts 164 and 194 appear to have a common font size 166 because the text 164 may be displayed at a greater font size than the text 194. Alternatively, the text size can change based on the depth so that text displayed at a greater depth appears to be smaller than text displayed at a smaller depth.

As represented by block 340e, in some implementations, displaying the visual representation includes categorizing the first distance into a first category of a plurality of categories that are associated with respective rendering depths including a first rendering depth associated with the first category, and selecting the first rendering depth as the second distance. More generally, in various implementations, the device categorizes the current depth-of-focus into one of several tiers and the device displays the visual representation at a depth that corresponds to a tier of the depth-of-focus.

As represented by block 340f, in some implementations, the audible signal data corresponds to a sound being generated within the region of interest and the visual representation includes a textual description of the sound being generated within the region of interest. For example, as described in relation to FIG. 2, in some implementations, the visual representation 232 includes non-verbal elements. For example, the visual representation 232 includes a description of what a person speaking in the environment is doing (e.g., standing, sitting, etc.). In some implementations, the visual representation 232 includes an indication of other events in the environment (e.g., “door opens”).

As represented by block 340g, in some implementations, the method 300 includes identifying a second region of interest that is located at a third distance from the current point-of-view, receiving, via the audio sensor, a second audible signal and converting the second audible signal to second audible signal data, and displaying, on the display, a second visual representation of the second audible signal data at a fourth distance from the current point-of-view that is a function of the third distance between the second region of interest and the current point-of-view. For example, as shown in FIG. 1E, the electronic device 20 identifies the second region of interest 180 that is at the third depth 172 and the electronic device 20 displays the second visual representation 190 at the fourth depth 192 that is based on (e.g., the same as or close to) the third depth 172.

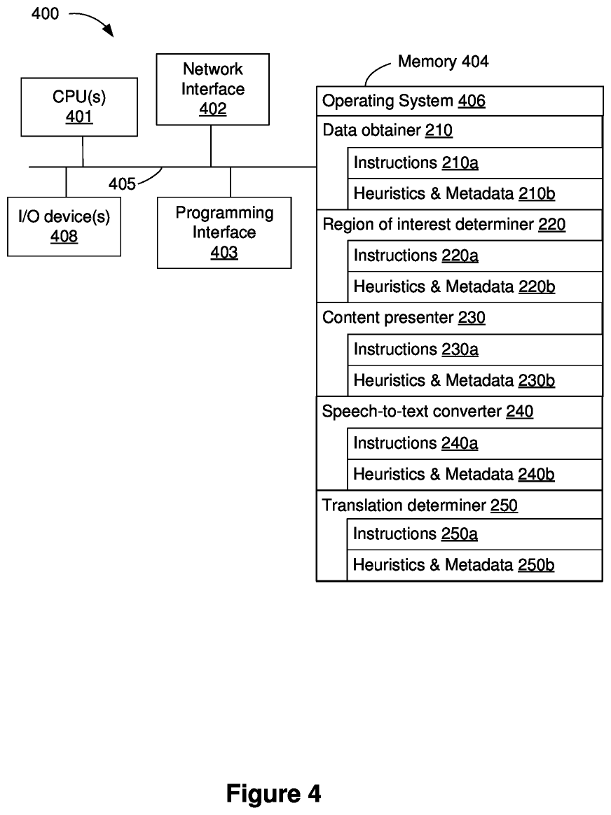

FIG. 4 is a block diagram of a device 400 in accordance with some implementations. In some implementations, the device 400 implements the electronic device 20 shown in FIGS. 1A-1F and/or the system 200 shown in FIG. 2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the region of interest determiner 220, the content presenter 230, the speech-to-text converter 240 and the translation determiner 250. In various implementations, the device 400 performs the method 300 shown in FIG. 3.

In some implementations, the data obtainer 210 includes instructions 210a, and heuristics and metadata 210b for obtaining an image of an environment (e.g., the image 212 shown in FIG. 2) and/or audible signal data (e.g., the audible signal data 214 shown in FIG. 2). In some implementations, the data obtainer 210 performs at least some of the operation(s) represented by blocks 310 and 330 in FIG. 3.

In some implementations, the region of interest determiner 220 includes instructions 220a, and heuristics and metadata 220b for identifying a region of interest within an environment (e.g., the region of interest 70 shown in FIG. 1B, the second region of interest 180 shown in FIG. 1E, and/or the region of interest indicated by the region of interest indication 222 shown in FIG. 2). In some implementations, the region of interest determiner 220 performs at least some of the operation(s) represented by block 320 in FIG. 3.

In some implementations, the content presenter 230 includes instructions 230a, and heuristics and metadata 230b for presenting an XR environment (e.g., the XR environment 110 shown in FIG. 1B) and displaying visual representations (e.g., the visual representation 160 shown in FIG. 1C, the second visual representation 190 shown in FIGS. 1E and 1F, and/or the visual representation 232 shown in FIG. 2). In some implementations, the content presenter 230 performs at least some of the operation(s) represented by blocks 310 and 340 in FIG. 3.

In some implementations, the speech-to-text converter 240 includes instructions 240a, and heuristics and metadata 240b for converting speech into text (e.g., for converting the speech 60 shown in FIG. 1A into the text 164 shown in FIG. 1D). In some implementations, the speech-to-text converter 240 performs at least some of the operation(s) represented by block 340c in FIG. 3.

In some implementations, the translation determiner 250 includes instructions 250a, and heuristics and metadata 250b for translating speech from a source language to a target language. In some implementations, the translation determiner 250 performs at least some of the operation(s) represented by block 340c in FIG. 3.

In some implementations, the one or more I/O devices 408 include an input device for obtaining an input. In some implementations, the input device includes a touchscreen for detecting touch inputs, an image sensor for detecting 3D gestures, and/or a microphone for detecting voice inputs and/or sounds originating in a physical environment of the device (e.g., for detecting the speech 60 shown in FIG. 1A). In some implementations, the one or more I/O devices 408 include one or more image sensors for capturing images. For example, the one or more I/O devices 408 include a first image sensor (e.g., a scene-facing camera, for example, the image sensor 30 shown in FIG. 1A) for capturing images of a physical environment and a second image sensor (e.g., a user-facing camera) for capturing images of an eye of the user (e.g., for capturing the gaze data 224 shown in FIG. 2).

In various implementations, the one or more I/O devices 408 include a video pass-through display which displays at least a portion of a physical environment surrounding the device 400 as an image captured by a camera (e.g., for displaying the XR environment 110 shown in FIG. 1B as a video pass-through of the physical environment shown in FIG. 1A). In various implementations, the one or more I/O devices 408 include an optical see-through display which is at least partially transparent and passes light emitted by or reflected off the physical environment (e.g., for displaying the XR environment 110 shown in FIG. 1B as an optical see-through of the physical environment shown in FIG. 1A).

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

Implementations described herein contemplate the use of gaze information to present salient points of view and/or salient information. Implementers should consider the extent to which gaze information is collected, analyzed, disclosed, transferred, and/or stored, such that well-established privacy policies and/or privacy practices are respected. These considerations should include the application of practices that are generally recognized as meeting or exceeding industry requirements and/or governmental requirements for maintaining the user privacy. The present disclosure also contemplates that the use of a user's gaze information may be limited to what is necessary to implement the described embodiments. For instance, in implementations where a user's device provides processing power, the gaze information may be processed at the user's device, locally.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device comprising an audio sensor, a display, one or more processors, and a memory:
presenting a representation of a three-dimensional (3D) environment from a current point-of-view;
identifying a region of interest within the 3D environment, wherein the region of interest is located at a first distance from the current point-of-view;
receiving, via the audio sensor, an audible signal and converting the audible signal to audible signal data; and
displaying, on the display, a visual representation of the audible signal data at a second distance from the current point-of-view that is based on the first distance between the region of interest and the current point-of-view.

2. The method of claim 1, wherein the first distance represents a first depth at which the region of interest is located and the second distance represents a second depth at which the visual representation is displayed.

3. The method of claim 1, wherein the second distance is within a threshold distance of the first distance.

4. The method of claim 1, wherein the visual representation of the audible signal data includes a transcript of speech represented by the audible signal data, and the method further comprises:
generating the transcript by performing a speech-to-text operation on the audible signal data.

5. The method of claim 4, further comprising translating the speech from a first language to a second language associated with the device.

6. The method of claim 1, wherein the visual representation includes text that is displayed at a threshold size.

7. The method of claim 1, wherein the region of interest includes a representation of a person that is generating the audible signal, and the visual representation includes a transcript that is displayed near the representation of the person.

8. The method of claim 1, wherein displaying the visual representation comprises:
categorizing the first distance into a first category of a plurality of categories that are associated with respective rendering depths including a first rendering depth associated with the first category; and
selecting the first rendering depth as the second distance.

9. The method of claim 1, wherein identifying the region of interest comprises:
localizing the audible signal to identify a source of the audible signal in the 3D environment; and
selecting a location of the source of the audible signal as the region of interest.

10. The method of claim 1, wherein identifying the region of interest comprises:
detecting movement of an object in the 3D environment; and
selecting the object as the region of interest.

11. The method of claim 11, wherein detecting the movement of the object comprises detecting the movement based on a combination of an image of the 3D environment and depth data of the 3D environment.

12. The method of claim 1, wherein identifying the region of interest comprises:
identifying the region of interest based on gaze data that indicates a gaze position of a user of the device.

13. The method of claim 1, wherein identifying the region of interest comprises:
identifying the region of interest based on a saliency map of the 3D environment.

14. The method of claim 1, wherein the first distance represents a distance between the device and the region of interest within the 3D environment, and the method further comprises:
determining the first distance based on a combination of depth data from a depth camera and sensor data from a lidar.

15. The method of claim 1, wherein converting the audible signal to the audible signal data comprises:
converting the audible signal to the audible signal data in response to obtaining a user input that corresponds to a request to display visual representations corresponding to the 3D environment.

16. The method of claim 1, wherein presenting the representation of the 3D environment comprises displaying a video pass-through of a physical environment by displaying a two-dimensional (2D) representation of objects that are in a field-of-view of an image sensor of the device.

17. The method of claim 1, wherein the audible signal data corresponds to a sound being generated within the region of interest and the visual representation includes a textual description of the sound being generated within the region of interest.

18. The method of claim 1, further comprising:
identifying a second region of interest that is located at a third distance from the current point-of-view;
receiving, via the audio sensor, a second audible signal and converting the second audible signal to second audible signal data; and
displaying, on the display, a second visual representation of the second audible signal data at a fourth distance from the current point-of-view that is based on the third distance between the second region of interest and the current point-of-view.

19. A device comprising:
one or more processors;
an audio sensor;
a display;
a non-transitory memory; and
one or more programs stored in the non-transitory memory, which, when executed by the one or more processors, cause the device to:
present a representation of a three-dimensional (3D) environment from a current point-of-view;
identify, within the 3D environment, a region of interest that is located at a first depth from the current point-of-view;
receive, via the audio sensor, an audible signal and convert the audible signal to audible signal data; and
display, on the display, a visual representation of the audible signal data at a second depth from the current point-of-view that is a function of the first depth.

20. A non-transitory memory storing one or more programs, which, when executed by one or more processors of a device including a display and an audio sensor, cause the device to:
present a representation of a three-dimensional (3D) environment;
identify a region of interest that is located at a first position within the 3D environment;
receive, via the audio sensor, an audible signal and convert the audible signal to audible signal data; and
display, on the display, a visual representation of the audible signal data at a second position that is a function of the first position.
